(19) United States
(12) Patent Application Publication
(10) Pub. No.: US 2008/0215968 A1
(43) Pub. Date: Sep. 4, 2008

(54) System and Method for Managing Content of Rich Media

(75) Inventor: Damian Bekerman, Kiryat Motzkin (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: DYNAMIC FLASH LTD., Kiryat Motzkin (IL)

(21) Appl. No.: 11/720,076

(22) PCT Filed: Nov. 24, 2005
(86) PCT No.: PCT/IL05/01248

§ 371 Date: May 24, 2007

Related U.S. Application Data
(60) Provisional application No. 60/630,203, filed on Nov. 24, 2004.

(51) Int. Cl. G06F 17/00

(52) U.S. Cl. 715/255

(57) ABSTRACT

A method for editing rich media content in a computerized device. The rich media content is stored in a static or binary file. The binary file is copied into storage operatively attached to the computerized device and decompiled and component s of the rich media content are extracted, (FIGS. 5 & 6). Properties of the components of the rich media content are presented and the properties are edited, (FIGS. 5 & 6). Preferably, during editing the modified rich media content is displayed in real time. An edited file including modified rich media content is stored preferably in lieu of the original binary file:

### FIELD AND BACKGROUND OF THE INVENTION

The present invention relates to a system and method for modifying rich media applications, and, more particularly, to a system and method for editing and managing rich media content of an Internet site.

Internet or Web pages of the World Wide Web (www) often use rich media in addition to text, graphics files (e.g. gif, jpeg or png), audio files (e.g. mid or .wav), full-motion moving picture components, and interactive multimedia content. The presentation of rich media requires a media player or Web browser plug-in such as Macromediat Flash™, or Macromedia® Shockwave™', (Macromedia, Inc., San Francisco, Calif., USA) QuickTime (Apple Computer Inc.), Windows Media (Microsoft, Inc.), Real Player (Real Networks Inc.)

Macromedia® Flash™, or simply Flash™, refers to both a multimedia authoring program and the Macromedia® Flash™ Player, the virtual machine application used to run Flash files that utilize vector and raster graphics, a native scripting language called ActionScript and bidirectional streaming of video and audio. Macromedia® Flash™ uses a file format known as SWF built mainly of two elements, vector based objects and images. Once created, SWF files can be played by the Macromedia® Flash™ Player, working either as a browser plug-in or as a standalone (executable) player. SWF files can also be encapsulated with the player, creating a self-running SWF movie called projector. The SWF is in a binary format, using zlib compression. Zlib is an open-source, cross-platform data compression library by Jean-loup Gailly and Mark Adler and is an abstraction of the DEFLATE compression algorithm used in their gzip file compression program. The SWF format aims to store all data using as few bits as possible, therefore reducing redundancy. The SWF format is not an open format. In comparison, another file type used for rich media is scalable vector graphic (SVG), which is based on extensible mark-up language (XML) and being based on text SVG is more easily read and edited than SWF. Nevertheless, SWF files can be decompiled into source code and components. Several commercially available programs extract graphics, sounds and program code from swf files. Intentional obfuscation of the SWF files makes extraction of components difficult.

File types related to Flash.™ applications include the SWF files which are compiled files that are not intended to be edited. Flash source files FLA (.fla) contain source material. Flash.™ authoring software can edit and compile FLA files into the SWF files. The FLA format is proprietary to Macromedia Inc. An SWC (.swc) file format is used for distributing components. The SWC file contains a compiled clip, the component's ActionScript class file, and other files that describe the component.

ActionScript is an ECMAScript-based programming language used for controlling Flash™ movies and applications. Since both ActionScript and JavaScript are based on the same ECMAScript syntax, fluency in one easily translates to the other. However, the client model of JavaScript deals with the structure of browser windows, documents and forms, and ActionScript deals with the structure and interactivity of Macromedia® Flash™ movies, which may include animations, audio, text and client-side logic Actionscript files (.as) contain ActionScript source code in source files. FLA files can also contain Actionscript code directly.

Content management is a set of processes and technologies that support the evolutionary life cycle of digital information or digital content. The digital content life cycle consists of six primary phases: create, update, publish, translate, archive and retire. For example, an instance of digital content is created by one or more authors. Over time the content may be edited. One or more individuals may provide some editorial oversight thereby approving the content for publication. Later the content may be superseded by another form of content and thus retired or removed from use.

A content management system includes features such as: identification of all key users and their roles, assignment of responsibility to different users dependent on different instances of content types, definition of work flow tasks, messaging so that content managers are alerted to changes in content, tracking multiple versions of a single instance of content and publishing the content to a repository, e.g Web site. A Web Content Management System is a type of content management system software used for managing websites. The Web content management system manages content e.g. text, graphics, links, etc. for distribution on a Web server. Usually Web content management software provides tools where users with little or no knowledge of programming languages (e.g. HTML) can create and manage content with relative ease of use. Most systems use a database to hold content, and a presentation layer displays the content to regular website visitors based on a set of templates. Management of the software is typically done through a web browser, but some systems may be modified in other ways.

Reference is now made to FIG. 1 of a prior art Web content authoring and management process 10. Process 10 is an inherently collaborative process performed by a team including a project manager 101 responsible for creating and editing content, a Web designer 103 responsible for tuning the content message and the style of delivery, a Web programmer 105 responsible to write and maintain code (e.g. HTML) according to the requirements of both project manager 101 and Web designer 103. The project may further require a database programmer 107. Web programmer 105 and/or data base programmer 107 use a content management system 109 to update a rich media application 111. If the rich media is installed as part of a Web site, typically an information system administrator (not shown) installs the new rich media content on the Web site. A critical aspect of content management is the ability to manage versions of content as the content evolves. A customer 113, for instance Sam a marketing manager of XYZ Ltd. requires updating an instructional moving picture including audio on XYZ Ltd. Web site. Sam contacts (step 115) the company (including 101, 103, 105 and 107) which supplied the original content to provide the required modifications to the Web site including the moving picture.

Reference is now made to FIG. 2 which shows in more detail some of the steps of prior art process 10. Web designer 103, in cooperation with project manager 101, designs and specifies (step 201) the rich media content required in the updated Web site. Web programmer 105 typically uses rich media authoring software to generate source files (e.g. FLA). Web programmer 105 writes (step 203) an ActionScript according to the specification and structures (step 205) the Action Script as required using typically extensible mark-up language (XML). XML is used to facilitate sharing of data across different systems, particularly systems connected via the Internet. XML is used for management, display, and organization of data. Database programmer 107 performs database development (step 207) as required in the specification. At this point, the Web site is installed (step 209) at the server, typically by the system administrator; administration levels are defined (step 211) which authorize certain individuals to modify the content. The Web site is ready and accessible. When the content of the Web site needs to be updated (step 213), process 10 is begun again. Returning to the example and referring back to FIG. 1 (prior art), when Sam (customer 113) contacts (step 115) the company which originally supplied the rich media content along with the Web site, Sam finds that the company is no longer in business. After a search for appropriate source files (e.g. FLA) Sam is required to turn to a second company to provide the required update. Since source files used to produce the original rich media were not found, the second company is required to start process 10 from scratch.

There is thus a need for, and it would be highly advantageous to have a method of updating editing and managing rich media content, particularly of Web sites without requiring the original source files which generated the rich media content and in particular a method which does not require skilled programmers to implement.

### REFERENCES

http://en.wikipedia.org/wiki/Macromedia_flash
http://en.wikipedia.org/wiki/ActionScript
http://en.wikipedia.org/wiki/SGML
http://en.wikipedia.org/wiki/XML#History
http://en.wikipedia.org/wiki/Content_management
http://en.wikipedia.org/wiki/Web_Content_Management_System
http://en.wikipedia.org/wiki/Web_page
http://en.wikipedia.org/wiki/VML
http://en.wikipedia.org/wiki/SWF
http://en.wikipedia.org/wiki/Zlib

The terms “computer” and “computerized device” are used herein interchangeably and refer any device including a processor such as a general purpose computer, portable computer, personal digital assistant, a portable, mobile or cellular telephone, or a pocket or handheld computer.

The terms “rich media” and “multimedia” content are used herein interchangeably and refer to binary data which when read achieves a combination of effects including graphics, audio, text and/or interactive with any human sense.

The term “dynamic” as used herein refers to a file including rich media content and is defined herein as “readily editable”. The term “static” is used herein as in a “static” file which includes rich media content in typically a binary file which is not intended to be editable.

### SUMMARY OF THE INVENTION

According to the present invention there is provided a method for editing rich media content in a computerized device. The rich media content is stored in a static or binary file. The binary file is copied into storage operatively attached to the computerized device and decompiled. Components of the rich media content are extracted. Properties of the components of the rich media content are presented and the properties are edited. Preferably, during editing the modified rich media content is displayed in real time. An edited file including modified rich media content is stored preferably in lieu of the original binary file. Preferably, a content manager is generated which is used to perform further editing by a user of another computerized device. Preferably, the content manager is transferred to the other computerized device and the modified rich media content is transferred as a dynamic file to the other computerized device for the further editing using the content manager. Preferably, the content manager inputs a copy of the edited file, decompiles the edited file, presents a component of rich media content of the edited file to the user thereby allowing the user to edit a property of the rich media content. Preferably, an administration level is defined, permitted editing actions are defined for the administration level and the administration level is assigned to the user of the rich media content. Preferably, the binary file is in a format selected from the group consisting of SWF and SWC. Preferably, the decompiling includes parsing the binary file, thereby reading a component parameter and the parameter is written, thereby updating a text based mark-up language.

According to the present invention there is provided, a system for editing rich media content in a computerized device, wherein the rich media content is input as a binary file into storage of the computerized device. The system includes a software application installed in storage, and the application includes a decompiler which parses the binary file and extracts components of the binary file, an editor for editing by a user component parameters and a display which presents to the user in real time modified rich media content resulting from the editing. Preferably, the editor includes a visual editor and the editing includes visual editing. Preferably, the software application further includes a components generator which is used by the user to generate new components for including in the rich media content, a components library for adding new components to the rich media using the editor. Preferably a content manager which is generated by the software application, is operative to decompile and to edit the modified rich media content. A transfer mechanism transfers the content manager and the modified rich media content as dynamic file to a computer and the transfer mechanism preferably uses a network interface. Preferably, the content manager is used by a user of the computer to: define an administration level, and for the administration level define permitted further modifications to the modified rich media content. Preferably, the software application further includes a data base connection builder which modifies the rich media content with data from a data base attached to the computer.

According to the present invention there is provided a program storage device readable by a machine, tangibly embodying a program of instructions executable by the machine to perform a method for editing rich media content in a computerized device, wherein the rich media content is stored in a binary file in storage attached to the computerized device, the method as disclosed herein.

### BRIEF DESCRIPTION OF THE DRAWINGS

The invention is herein described, by way of example only, with reference to the accompanying drawings, wherein:

FIG. 1 (prior art) is a drawing of a conventional process for developing a rich media application;

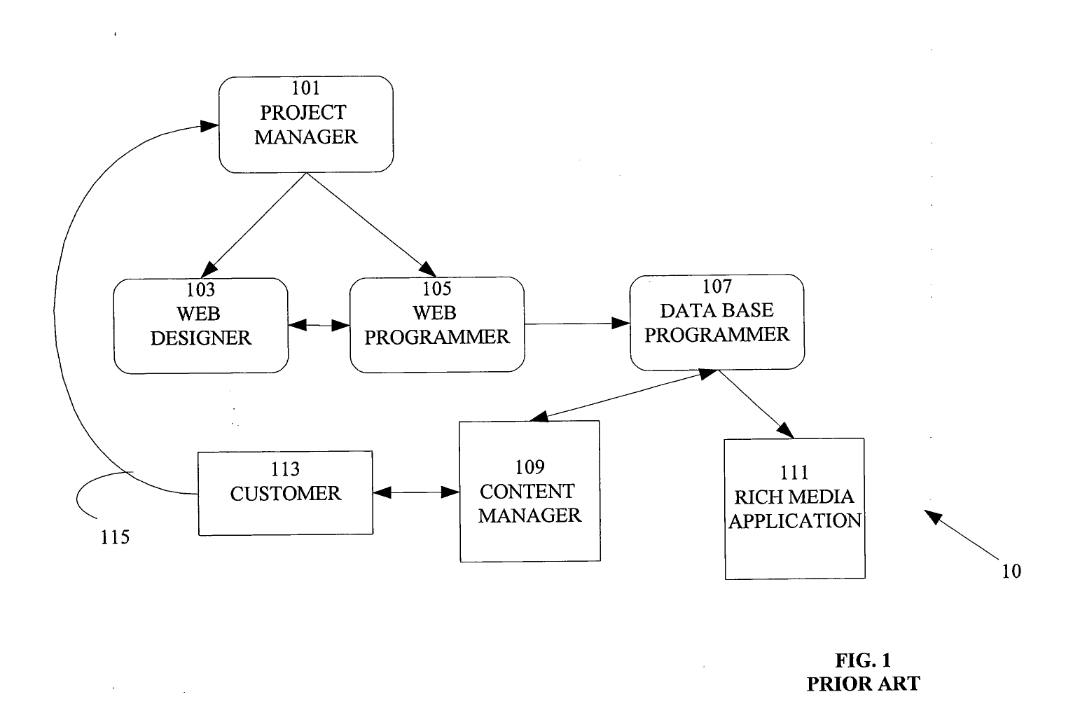

FIG. 2 (prior art) is a flow drawing of greater detail of the conventional process of FIG. 1;

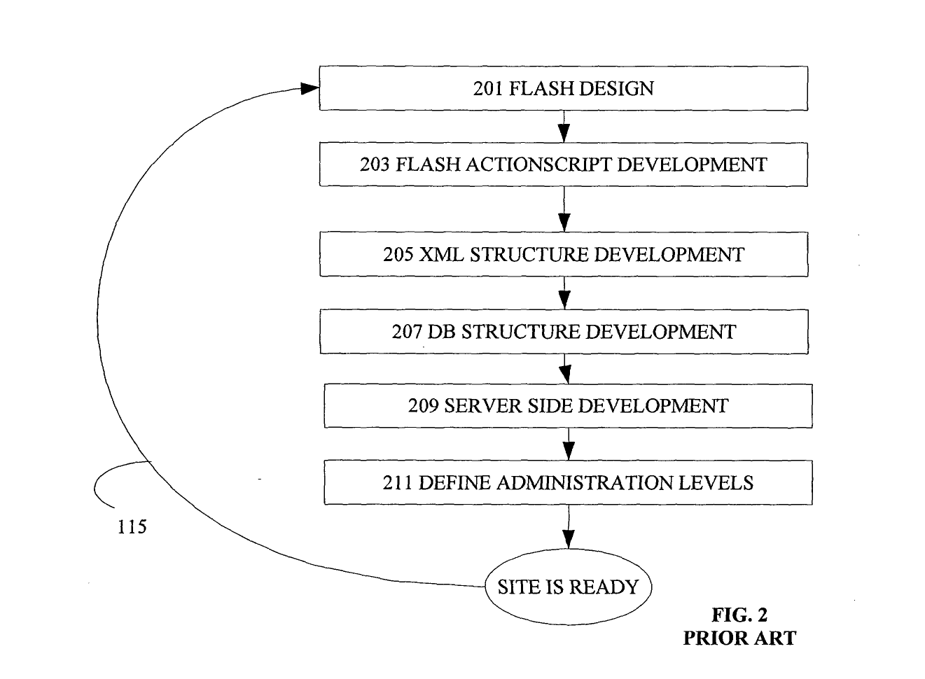

FIG. 3 is a flow drawing of a process for developing rich media applications according to an embodiment of the present invention;

FIG. 4 is a simplified drawing of a computer used for implementing a process, according to an embodiment of the present invention;

FIG. 5 is a drawing of a simplified system, according to embodiments of the present invention;

FIG. 6 is a drawing of the system of FIG. 5, in more detail according to embodiments of the present invention; and

FIG. 7 is a flow diagram of a simplified example, according to embodiments of the present invention.

### DESCRIPTION OF THE PREFERRED EMBODIMENTS

The present invention is of a system and method for updating rich media content. Specifically, the method includes decompiling a binary file which contains the rich media content, editing the content and compiling the edited content into a edited binary file in lieu of the original binary file.

The principles and operation of a system and method for updating rich media content, according to the present invention, may be better understood with reference to the drawings and the accompanying description.

It should be noted, that although the discussion herein relates specific formats of imported and exported binary files, (e.g. SWF and SWC) the present invention may, by non-limiting example, alternatively be configured as well using other import and export formats such as SVG. It should be noted that while the discussion herein is directed primarily to presenting rich media in Web sites which are read and presented by a Web browser, embodiments of the present invention are applicable to other rich media applications such as in real time simulators, education and electronic commerce and entertainment.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

By way of introduction, principal intentions of the present invention are to: (1) provide a method for updating rich media content, e.g. Web site when source files used to generate the rich media content are not available, (2) provide a method for updating rich media content without requiring skilled programmers, (3) provide a method to manage rich media content, such as assigning administration levels to particular users and permissions to change specific properties of the rich media content.

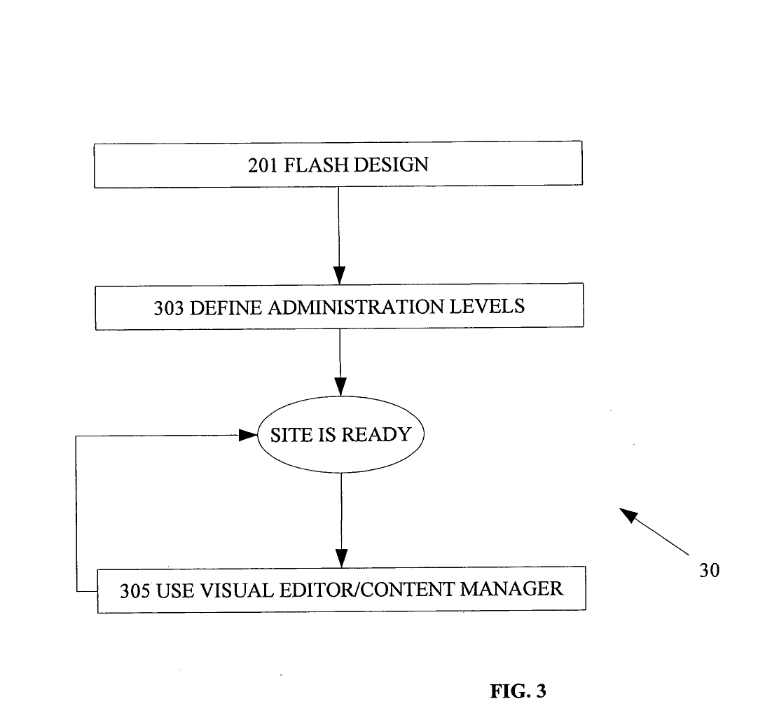

Referring now to the drawings, FIG. 3 illustrates a simplified method 30, according to embodiments of the present invention. A rich media application is designed (step 201) or an existing rich media application design is modified. Administration levels are assigned (step 303) to particular users of the application and authorization is given to the users to modify particular properties of specific components of the rich media content. One or more of the users may modify (step 305) the rich media content by using a visual editor included in the application.

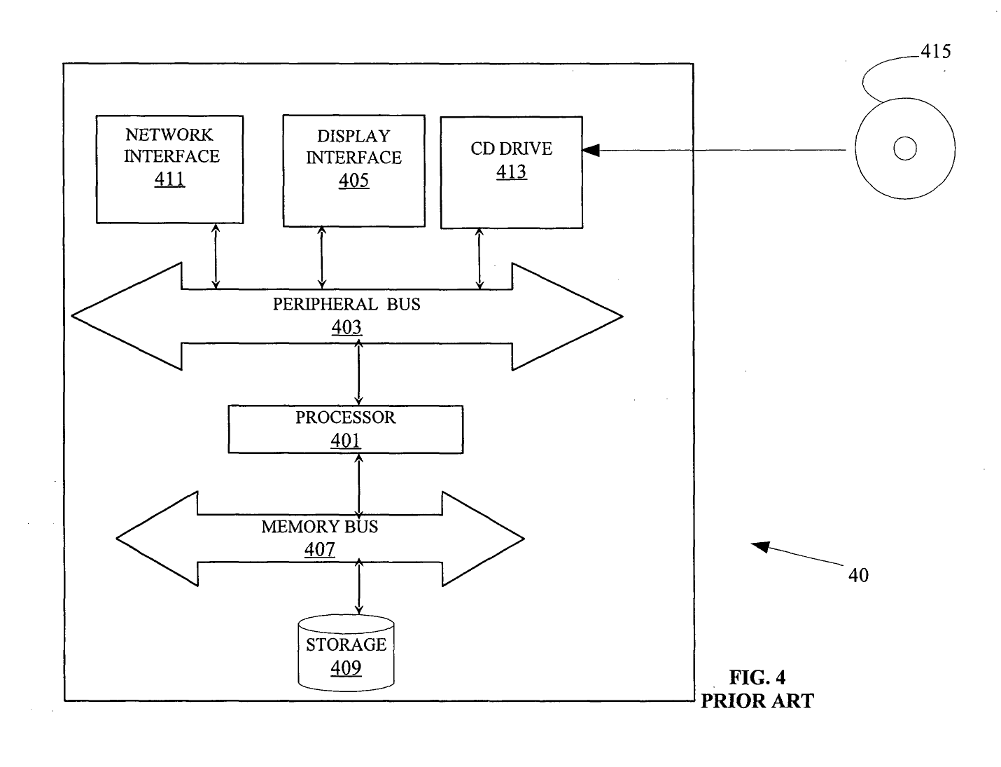

Reference is now made to FIG. 4, which illustrates a conventional computer 40 in which an application is installed for editing rich media applications, according to embodiments of the present invention. Computer 40 includes a processor 401, a storage mechanism including a memory bus 407 to store information in storage 409, a display interface 405 and a network interface 411, each operatively connected to processor 401 with a peripheral bus 403. Computer 101 further includes a data input mechanism 413, e.g. disk drive from a program storage device 415, e.g. optical disk. Data input mechanism 411 is operatively connected to processor 401 with peripheral bus 403.

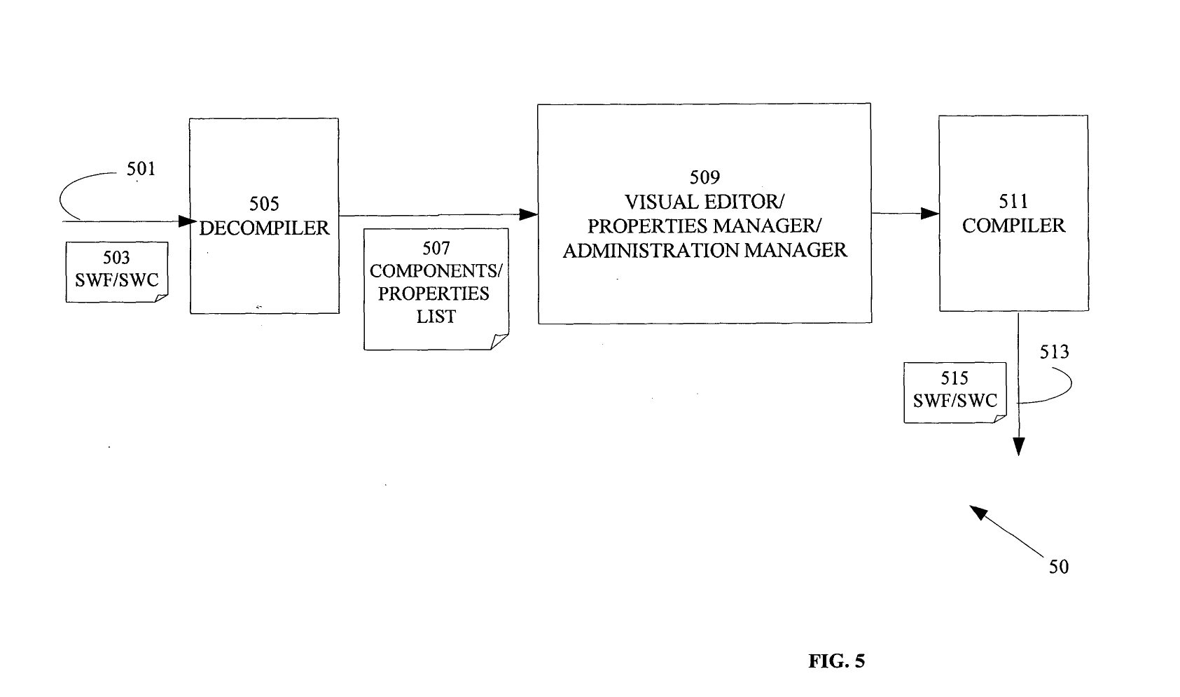

Reference is now made to FIG. 5, which illustrates a simplified application 50 for editing rich media content, according to an embodiment of the present invention. A file 503, which includes rich media content, typically in a binary format, e.g. SWF which is not intended to be edited is input (step 501) to a decompiler 505. Decompiler parses file 503 and extracts multimedia components and the properties and parameters of the multimedia components in a data structure or list 507. Components and properties list 507 is preferably internally structured using extensible mark up language (XML). Preferably, property list 507 is saved both in an XML file and in a SWF format for output. The list of components is presented on the computer display and preferably a visual editor 509 is used by a user of the computer to edit the components properties and parameters, or add new components. Visual editor 509 as well as all the modules of the application works in a visual way, function by for instance drag and drop, visual selecting and resizing etc. The edited components and new components may be displayed in real time multimedia using for instance an Internet browser window launched by the application. When the user has finished editing the rich media content, a file which includes the edited properties, e.g SWF 515 is compiled (step 513) by compiler 511.

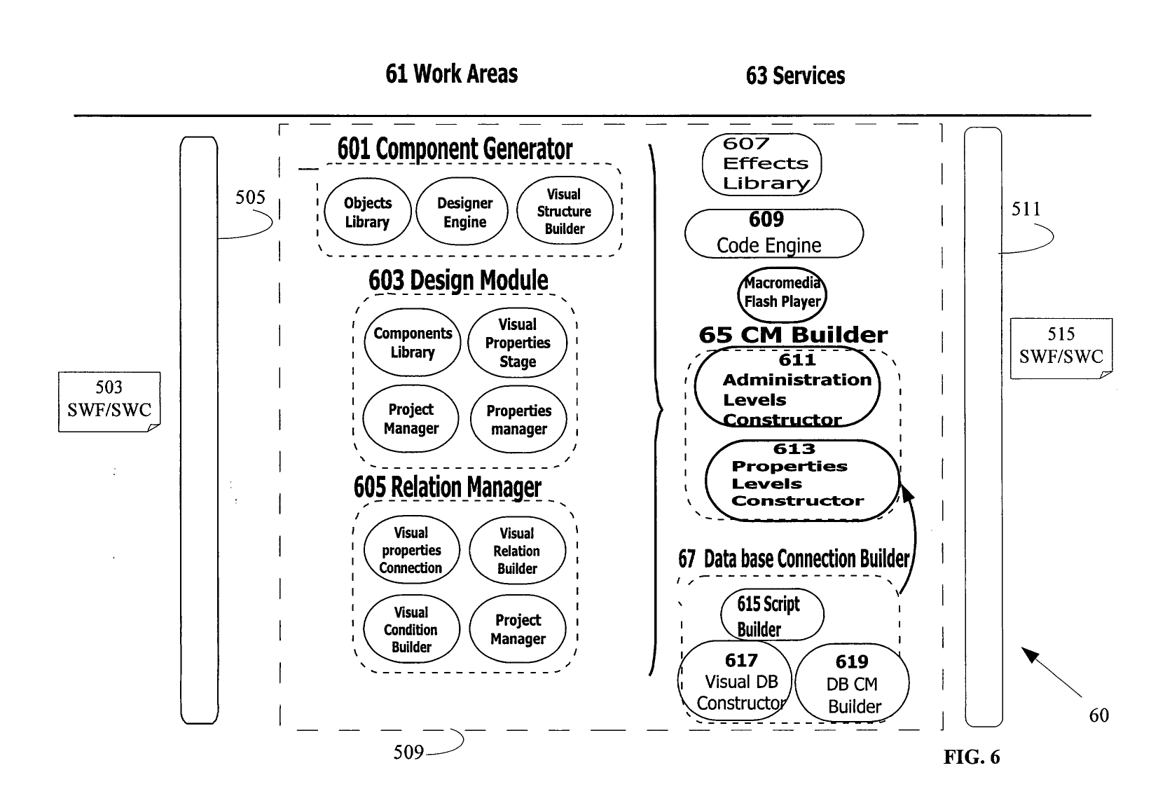

Reference is now made to FIG. 6, which illustrates a system drawing 60 showing more details of application 50, according to the present invention.

### 61 Work Areas: Main Modules

Component Generator 601 creates the structure of components extracted from SWF file 503. The structure of SWF file 503 is determined (from decompiling) and XML files and/or SWF format are generated which correspond to the components of SWF file 503. The XML files and/or SWF format include all the properties and parameters of the extracted components. Through the visual interface it is possible to add new components or objects, properties and effects which are stored in libraries and also managed in XML files and/or SWF format. The user creates and defines the component structure, groups and un-groups objects, defines object relations, and defines the dynamic properties for every component. All data is stored in XML files and/or SWF format preferably in “encoding UTF-8” format. Design module 603 enables changing the dynamic properties in each component that is defined using component generator 601. Relation manager 605 creates the connections and relations between components. The relations and connections can preferably be configured by the condition wizard, that gives in a step by step wizard the possibility to add conditions structures (if, else structure) to the relation or connections in a visual way.

### 63 Services:

Services 63 include sub-modules that can be used from any of the main modules 601-605. An effects library 607 is a list of effects developed by the user which are created and may be added to the content of imported SWF file 503. Code engine 609 translates each action of the user using the visual interface to xml code structure. The user can change properties using the visual interface or by directly editing the xml code.

### 65 Content Manager Builder:

A content manager is a miniature script language application, e.g. Javascript, or other stand alone application, created, according to embodiments of the present invention by content manager builder 65. The function of the content manager is to update for instance through the Internet, rich media components enabled by Design module 603. The content manager works similarly as the application that created it. Administration Levels Constructor 611 sets administration levels, preferably according to username and password for each user of the content manager. Administration levels constructor 611 determines the components that appear for editing to each user, enables adding, changing and/or deleting components, and enables adding, changing or deleting users with permission to change components of the rich media content. Properties Level Constructor 613 sets the editable component properties as shown for each component.

### 67 Data Base (DB) Connection Builder:

A dynamic DB connection builder 67 connects any DB format into a component in a visual and friendly way. Data Base (DB) Connection Builder 67 also creates the database content associated with the content manager. Script builder 615 creates a connection to the database depending the selected server language. Visual DB constructor 617 shows a database visually, showing every table, every field and relations between tables. The user can select a field from a table and drag a connection to a selected item in the component. Data Base Content Manager Builder 619 builds a database for content manager builder module 65 for managing data base content by the content manager.

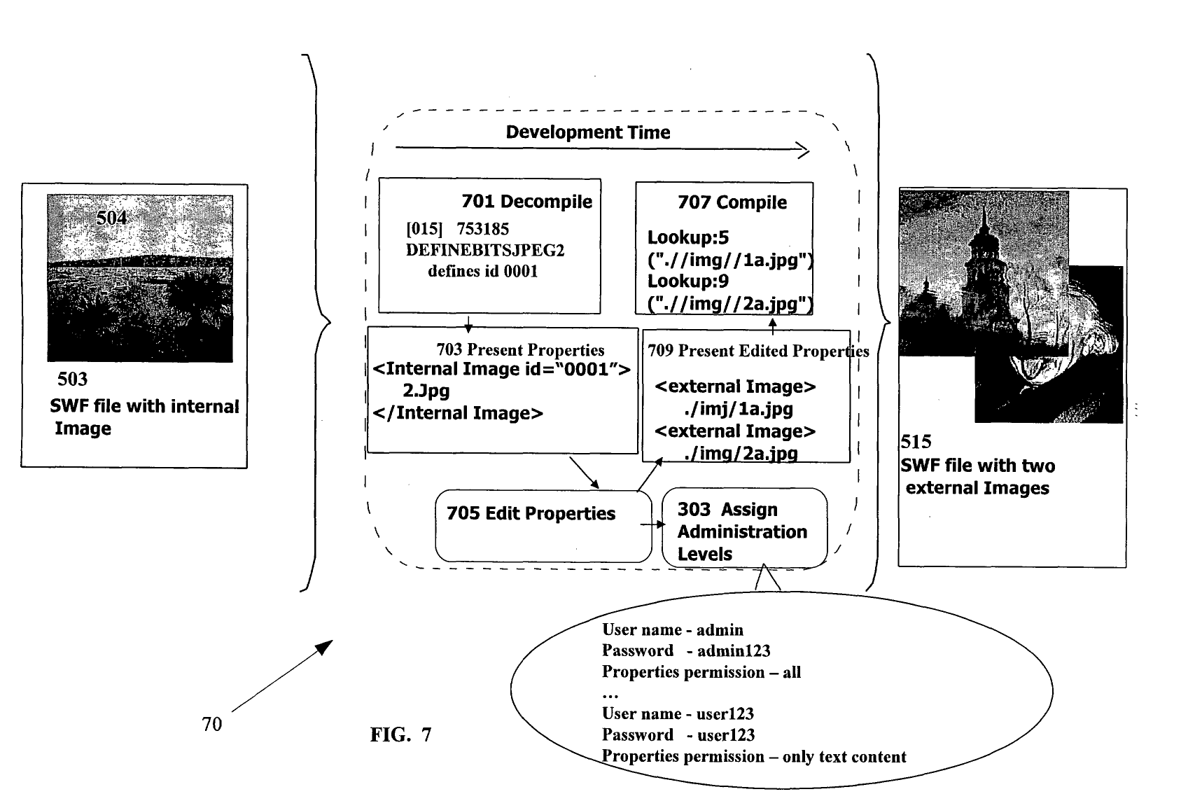

Reference is now made to FIG. 7, which illustrates, by example 70, operation of application 50 and system 60, according to embodiments of the present invention. SWF file 503 is input (step 501) into decompiler 505 which decompiles (step 701). Decompiler 505 inputs binary code: [instruction]: data [015]: 753185 which defines data area including an internal image 504 in jpeg format stored within SWF file 503. Decompiler 505 assigns an identification code″ id 0001″ to the static internal image, and presents (step 703) visually and/or in XML code the jpeg image as a component of SWF file 503, and </internal image> as a property of the jpeg image. It should be appreciated that SWF 503 is “static” since internal image 504 is included explicitly in SWF 503. Using for instance a properties manager of design module 603, properties are visually edited (step 705) and edited properties are visually presented (step 709). In example 70, internal image 504 is replaced with two external images and presented (step 709) as:

<external image>./imj/1a.jpg
<external image>./imj/2a.jpg

The properties list includes jpeg images 1a and 2a as external images preferably connected to a data base using data base connection builder 67. Output SWF file 515 is compiled (step 707) which may be configured using relation manager 605 to look up in a locally stored data base either image 1a or image 2a depending on the details of the relations chosen. It is now appreciated that output SWF file 515 is “dynamic” and may be edited by a customer.

According to embodiments of the present invention, system 60 is used to generate a content manager, for instance a Javascript or Applet or other stand alone application which is provided to a customer, for instance over the Internet along with editable SWF file 515. Content manager allows the customer to assign administration levels, for instance only an administrator is allowed to change components, and properties, for instance choose which external image will be displayed, whereas any user may change text content displayed.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact design and operation shown and described, and accordingly, all suitable modifications and equivalents may be resorted to, falling within the scope of the invention.

While the invention has been described with respect to a limited number of embodiments, it will be appreciated that many variations, modifications and other applications of the invention may be made.

What is claimed is:

1. A method for editing rich media content in a computerized device, wherein the rich media content is stored in a binary file, the method comprising the steps of:
(a) inputting the binary file by copying the binary file into storage operatively attached to the computerized device;
(b) decompiling the binary file, thereby extracting at least one component of the rich media content;
(c) presenting a property of said at least one component of the rich media content; and
(d) editing said property, thereby storing in said storage an edited file including modified rich media content.

2. The method, according to claim 1, further comprising the step of:
(e) displaying in real time said modified rich media content.

3. The method, according to claim 1, wherein said edited file is an edited binary file, further comprising the step of:
(e) storing in memory said edited file in lieu of the binary file.

4. The method, according to claim 1, further comprising the step of:
(e) generating a content manager for performing further editing by a user of another computerized device.

5. The method, according to claim 4, further comprising the step of:
(f) transferring said content manager to said another computerized device
(g) transferring said modified rich media content as a dynamic file to said another computerized device for said further editing using said content manager.

6. The method, according to claim 4, wherein said content manager inputs a copy of said edited file, decompiles said edited file, presents a component of rich media content of said edited file to said user thereby allowing said user to edit a property of said rich media contents.

7. The method, according to claim 1, further comprising the steps of:
(e) defining an administration level;
(f) for said administration level defining permitted actions of said editing; and
(g) assigning said administration level to a user of the rich media content.

8. The method, according to claim 1, wherein the binary file is in a format selected from the group consisting of SWF and SWC.

9. The method, according to claim 1, wherein said decompiling includes the sub-steps of:
(i) parsing the binary file, thereby reading a parameter of said at least one component;
(ii) writing said parameter, thereby updating a text based mark-up language.

10. A system for editing rich media content in a computerized device, wherein the rich media content is input as a binary file into storage of the computerized device, the system comprising
(a) a software application installed in the storage, said application including:
(i) a decompiler which parses the binary file and extracts at least one component of the binary file;
(ii) an editor for editing by a user a parameter of said at least one component; and
(b) a display which presents to said user in real time modified rich media content resulting from said editing.

11. The system, according to claim 10, wherein said editor includes a visual editor and said editing includes visual editing.

12. The system, according to claim 10, wherein said software application further includes:
(iii) a components generator which is used by said user to generate new components for including in the rich media content.

13. The system, according to claim 10, wherein said software application further includes:
(iii) a components library for adding new components to the rich media using said editor.

14. The system, according to claim 10, further comprising:
(c) a content manager which is generated by said software application, wherein said content manager is operative to decompile and to edit said modified rich media content; and
(d) a transfer mechanism operatively attached to the computerized device which transfers said content manager and said modified rich media content as dynamic file to a computer.

15. The system, according to claim 14, wherein said transfer mechanism uses at least one network interface.

16. The system, according to claim 14, wherein said content manager is used by a user of said computer to: define an administration level, and for said administration level define permitted further modifications to said modified rich media content.

17. The system, according to claim 14, wherein said software application further includes:
(iii) a data base connection builder which modifies the rich media content with data from a data base operatively attached to said computer.

18. A program storage device readable by a machine, tangibly embodying a program of instructions executable by the machine to perform a method for editing rich media content in a computerized device, wherein the rich media content is stored in a binary file in storage attached to the computerized device, the method comprising the steps of:
(a) inputting the binary file by copying the binary file into storage operatively attached to the computerized device;
(b) decompiling the binary file, thereby extracting at least one component of the rich media content;
(c) presenting a property of said at least one component of the rich media content; and
(d) editing said property, thereby storing in said storage an edited file including modified rich modified content.
